(19) United States
(12) Patent Application Publication
(10) Pub. No.: US 2026/0002838 A1
(43) Pub. Date: Jan. 1, 2026

(54) METHOD AND DEVICE FOR DETERMINING THE TORSIONAL VIBRATION BEHAVIOR IN A DRIVE TRAIN IN AN AIRCRAFT

(71) Applicant: Rolls-Royce Deutschland Ltd & Co KG, Blankenfelde-Mahlow (DE)

(72) Inventors: Andreas REEH, Nürnberg (DE); Gunar REINICKE, Gauting (DE)

(21) Appl. No.: 19/253,709

(22) Filed: Jun. 27, 2025

(30) Foreign Application Priority Data
Jun. 28, 2024 (DE) 10 2024 118 443.4

(51) Int. Cl. G01M 13/028; H02H 7/08

(52) U.S. Cl. CPC G01M 13/028; H02H 7/08

(57) ABSTRACT

A method for detecting torsional vibration behavior of a drive train of an aircraft that is coupled to a permanent magnet synchronous motor as a drive includes at least one triggering of a short circuit in the permanent magnet synchronous motor in an operating state to apply at least one induced mechanical stimulation of the drive train. A torsional vibration response of the drive train to the induced mechanical stimulation is detected by a sensor device. A corresponding device is also provided.

This application claims the benefit of German Patent Application No. DE 10 2024 118 443.4, filed on Jun. 28, 2024, which is hereby incorporated by reference in its entirety.

### BACKGROUND

The present disclosure relates to a method for detecting torsional vibration behavior of a drive train of an aircraft, such as an airplane, and to a device for detecting the torsional vibration behavior of a drive train of an aircraft, such as an airplane.

Electric drives in an aircraft are today increasingly used to drive propellers or fans. Electric drives are also used in turbogenerators or hybrid drive systems of aircraft. Such drives are, however, employed not only in airplanes (e.g., for urban mobility), but also in drones or airships.

A common feature of these electric drives is that electric drives have drive trains that are subject, for example, to torsional vibration during operation.

A drive train may be all of the components that are set in rotation by the electric drive (e.g., also including rotating parts of the drive itself). This includes, for example, shafts, shaft parts, articulated shafts, differentials, bearings, gears, clutches, connected work machines, and engines (e.g., propellers, rotors, fans, compressor stages, turbine stages) and/or driven components. Such a drive train may in principle be modelled by a rotary vibration chain consisting of rotary masses and couplings (e.g., via springs and dampers). Drive trains situated in situ (e.g., in the operational aircraft, such as an airplane) may often demonstrate different torsional vibration behavior than drive trains that are situated, for example, in a test device. For meaningful detection of the torsional vibration behavior (e.g., of natural frequencies or resonant frequencies), the inertia, the stiffness, and the damping properties of the components of the drive train as a whole (e.g., in the installed state) should where possible be taken into account.

In the case of electric aircraft engines, mechanical vibrations (e.g., vibrations in the drive train) may constitute a risk during operation. Mechanical vibrations may also result in a reduction in the lifetime of the drive train and/or parts connected thereto when the parts are subjected, for example, to the mechanical stresses with specific frequencies over a specific period of time. There is a particular risk when an excitation frequency of the drive train coincides with or is close to a natural frequency of the drive train.

The occurrence and/or the change over time of the torsional vibration behavior is further an indicator for the functioning and/or the state of the drive train and/or the component connected thereto. Thus, for example, the change in a natural frequency of the drive train may be indicative of damage in a component (e.g., a shaft or a bearing) or of a component shifting in space. It is therefore also desirable, for example, to detect and store the torsional vibration behavior before each flight in order then to enable trend statements over relatively long periods of time about the status of the drive train as part of engine health management.

A test system for electric drives is known, for example, from EP 4 250 027 A1.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, methods and devices that may detect and/or evaluate the torsional vibration behavior of a drive train simply and efficiently are provided.

In a first aspect, a method is provided. It is assumed, for example, that there is a drive train that is coupled to a permanent magnet synchronous motor as the drive. This may be, for example, an electric drive in an electric airplane or be an electric drive that is coupled to an airplane internal combustion engine (e.g., as a starter, as a serial or parallel hybrid drive train, or as a starter generator).

In the method, during operation (e.g., when the electric drive is running), at least one short circuit (e.g., at least one 2-phase and/or at least one symmetrical 3-phase short circuit) is generated in or at the permanent magnet synchronous motor that induces a mechanical stimulation (e.g., a torsional stimulation) of the drive train. Because the stimulation is effected via the driving shaft, depending on the form and/or the duration of the induced mechanical stimulation, rotary vibrations are stimulated in the drive train.

Even though a symmetrical 3-phase short circuit has operational advantages, it is in principle possible to achieve mechanical stimulations of the drive train also with other forms of short circuits (e.g., with a 2-phase short circuit). Here too, a stimulation (e.g., in the form of a pulse on the drive train) is provided. The stimulation may then be asymmetrical and possibly greater than in the case of a symmetrical short circuit. It is in principle also possible that a plurality of different short circuits are generated for mechanical stimulation of the drive train.

The corresponding torsional vibration response of the drive train to the induced mechanical stimulation is then detected by a sensor device (e.g., with respect to the determination of at least one natural frequency and/or one resonant frequency of the drive train). For example, the torsional vibration response when the drive train coasts down after the short circuit has been triggered may thus be detected by the sensor device. The drive train may, for example, coast down with no load (e.g., in some circumstances, braking torque may still be present because of the aerodynamics, friction, or no-load losses in the electric machine).

Using such a method, it is, for example, possible to efficiently obtain statements about the torsional vibration behavior in situ (e.g., during operation, thus, without using a special test device) when the airplane engine coasts down from a high speed. Such a procedure is particularly well suited for airplane engines because airplane engines have an inherently high rotational inertia and are thus a good inherent test bed for mechanically investigating the vibration of the drive train.

The procedure is further suited, for example, for aircraft engines as aircraft engines are often tolerant to short circuits such that the loading may be withstood. This is often not required in other applications (e.g., in the automotive industry). The induced mechanical stimulations employed, for example, further do not cause damage to the drive train because the torsional vibration response does not impose excessive stress on the drive train in terms of the amplitude and duration.

Particularly simple checking of the rotary vibration behavior of the drive train is also possible using such a method without the need for expensive controllers or circuits. As will be described later, power electronics circuits that are present in any case may be used in order to generate the at least one short circuit (e.g., the at least one 2-phase and/or the at least one symmetrical 3-phase short circuit), and thus, the induced mechanical stimulation, in a predictable and reproducible fashion. This type of check may be performed, for example, regularly (e.g., as part of a pre-flight check).

In one embodiment of the method, the induced mechanical stimulation of the drive train takes the form of a shock, a pulse, a step function, and/or a ramp (e.g., a steep ramp). These types of mechanical stimulations of the drive train are to be generated efficiently with the aid of a short circuit (e.g., with the 2-phase and/or the symmetrical 3-phase short circuit) and stimulate the drive train at many frequencies such that the corresponding torsional vibration response allows statements about the mechanical properties of the drive train. The induced mechanical stimulations may, for example, be one-off stimulation or the consequence of periodic induced mechanical stimulations of the drive train. Thus, for example, multiple induced mechanical stimulations (e.g., a series of pulses at a certain interval) may be applied to the drive train during coasting down, where these mechanical stimulations are matched to a predetermined frequency of the drive train.

It is further possible that the at least one short circuit (e.g., the 2-phase short circuit and/or the symmetrical 3-phase short circuit) is generated at a relatively high number of revolutions of the drive train, where the triggering takes place in a range of the number of revolutions with no resonant frequency. The drive train is, for example, load-free. This would be an option for not loading the mechanical system excessively. Resonant stimulation is in principle also possible.

The detection of the torsional vibration behavior by the sensor device may be made in a different fashion. The progression of the torque may thus, for example, be detected as a reaction to the induced mechanical stimulation. The, for example, decaying fluctuation in the progression of the torque also characterizes the torsional vibration behavior of the drive train. Additionally or alternatively, an angular value may also be measured at the drive train. The angular value may be, for example, an angle, an angular velocity, or an angular acceleration. In principle, a measured value or also multiple measured values may be used jointly to characterize the torsional vibration behavior.

This detection relates to measured values in the time domain. Thus, for example, the decay behavior of the torsional vibration response may be determined, for example, via logarithmic decrement.

It is additionally or alternatively possible that the sensor device evaluates the torsional vibration response in the frequency range, for example, using a short-time Fourier transform and/or a wavelet transform for detecting natural frequencies and/or resonant frequencies.

In order to improve the meaningfulness of the analysis, in an embodiment of the method, the torsional vibration response may be filtered by a high-pass filter and/or a band pass filter of the sensor device.

The method is, however, suitable not only for obtaining current data about the torsional vibration behavior. It is in one embodiment also possible that the sensor device is coupled to a means (e.g., a device) for storing and/or evaluating the torsional vibration response over relatively long periods of time (e.g., of an engine health monitoring system). As part of the engine health monitoring, comparisons are, for example, made with historical data or fleet data in order to obtain statements about, for example, deteriorating properties of parts.

When detecting the torsional vibration behavior, be it as part of a current data detection or as part of the engine health monitoring, certain conditions that trigger an action may be defined. This may be, for example, the reduction of a number of revolutions, switching off a drive, or initiating a maintenance procedure. In each case, in such cases, the sensor device outputs, depending on the torsional vibration behavior, a signal that may trigger such an action.

In one embodiment of the method, the mechanical stimulation is effected via a, for example, installed device that is coupled to the drive train and may be utilized during ground operation in order to eliminate malfunctions during flight operation.

It is also possible that the at least one short circuit (e.g., the at least one 2-phase short circuit and/or the symmetrical 3-phase short circuit) is maintained after initiation at least over part of the (e.g., the whole) duration for which the drive train coasts down. Different implementations are possible, for example, for generating certain stimulations during the coasting down.

It is further possible that the mechanical stimulation is effected periodically, where, for example, at least one known resonance band of the drive train is omitted by the periodic stimulation. If the system is, for example, still stimulated by the preceding stimulations (e.g., pulses), an increase in amplitude may also be measurable during the resonance passage. This constitutes a particularly gentle variant.

A device for detecting the torsional vibration behavior of a drive train of an aircraft (e.g., an airplane) has a drive train that is coupled to a permanent magnet synchronous motor as a drive. A means (e.g., a device) serves here to generate at least one short circuit (e.g., at least one 2-phase short circuit and/or at least one symmetrical 3-phase short circuit) in the permanent magnet synchronous motor in order to apply at least one induced mechanical stimulation of the drive train. A sensor device then serves to detect the corresponding torsional vibration response of the drive train to the induced mechanical stimulation of the drive train (e.g., to determine at least one natural frequency of the drive train and), for example, in the case of a load-free drive train (e.g., during coasting down after application of the at least one short circuit, such as the at least one 2-phase short circuit and/or the at least one symmetrical 3-phase short circuit).

The means for generating the at least one short circuit (e.g., at least one 2-phase short circuit and/or the at least one symmetrical 3-phase short circuit) in the permanent magnet synchronous motor may, for example, take the form of an inverter circuit (e.g., a two-stage inverter circuit).

Alternatively, the means for generating the at least one short circuit (e.g., the at least one 2-phase short circuit and/or the at least one symmetrical 3-phase short circuit) in the permanent magnet synchronous motor may have a rectifier circuit (e.g., a three-phase rectifier circuit with open switches). Further, the symmetrical 3-phase short circuit may be triggered at the direct-current part (e.g., at a transistor circuit).

Such inverter circuits or rectifier circuits may be present in aircraft in conjunction with drives such that the inverter circuits or the rectifier circuits may be used efficiently to apply the at least one mechanical stimulation of the drive shaft.

Embodiments of such devices may be used in conjunction with an aircraft engine. The aircraft engine may, for example, have a propeller engine, a fan engine, a turbogenerator, or a hybrid drive system. Thus, for example, an output train of a hybrid drive system may be checked without the internal combustion system being operated.

The embodiments of the aircraft engines may be arranged, for example, in an airplane, an airship, or a drone.

It is self-evident to a person skilled in the art that a feature or parameter described in relation to one of the above aspects may be applied to any other aspect, unless these are mutually exclusive. Further, any feature or any parameter described here may be applied to any aspect and/or combined with any other feature or parameter described here, unless these are mutually exclusive.

### BRIEF DESCRIPTION OF THE DRAWINGS

FIG. 1 is a schematic illustration of a drive train in an airplane by which an embodiment of a method for detecting torsional vibrations may be performed;

FIG. 2 shows a flow chart of a first embodiment of the method;

FIG. 3 shows an example torsional vibration response of a drive train in the time domain;

FIG. 4 shows the example torsional vibration response of the drive train according to FIG. 3 in the frequency domain;

FIG. 5 shows an illustration of torque vibrations in a drive shaft after an induced mechanical stimulation by a symmetrical 3-phase short circuit;

FIG. 6 shows a spectrograph of torque vibrations after an induced mechanical stimulation by a symmetrical 3-phase short circuit;

FIG. 7 shows a first embodiment of a device for generating a symmetrical 3-phase short circuit using a circuit of a three-phase rectifier;

FIG. 8 shows a second embodiment of a device for generating a symmetrical 3-phase short circuit using a circuit of an inverter; and

FIGS. 9A-E show embodiments of induced mechanical stimulations.

### DETAILED DESCRIPTION

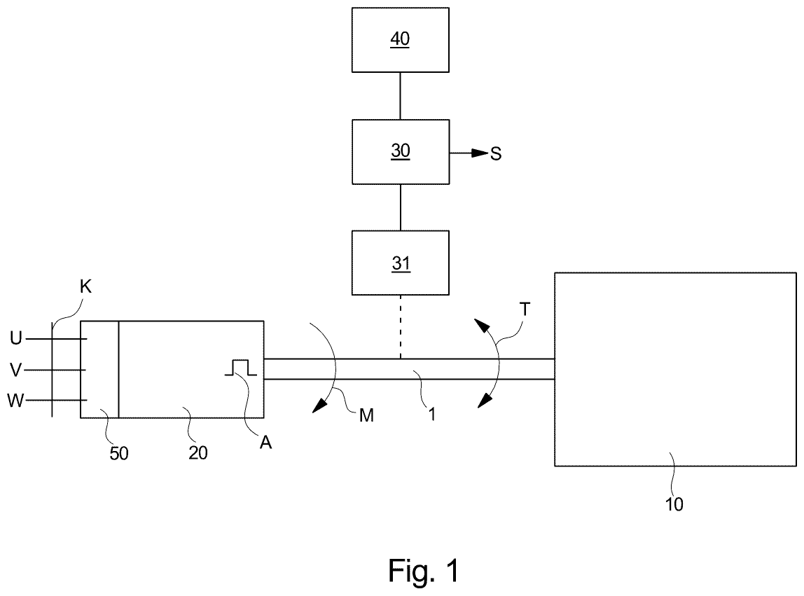

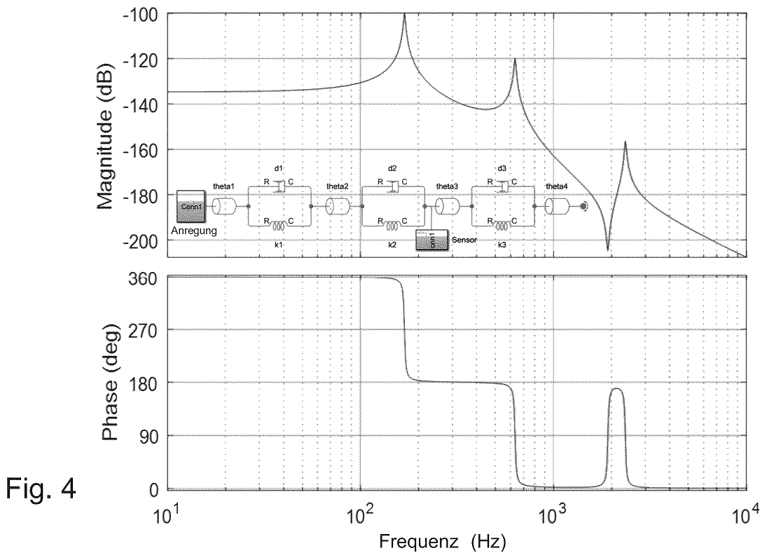

A device for detecting torsional vibration behavior T of a drive train 1 is illustrated schematically in FIG. 1. The drive train 1 is illustrated in a simplified form as a rectangle in FIG. 1. Actual embodiments of drive trains may have a series of shaft elements and components connected thereto that may be set in rotation. A drive train may be all of the components that are set in rotation by the electric drive (e.g., also including rotating parts of the drive itself). This includes, for example, shafts, shaft parts, articulated shafts, differentials, bearings, gears, clutches, connected work machines, and engines (e.g., propellers, rotors, fans, compressor stages, turbine stages) and/or driven components. A possible modelling of such a drive train is illustrated schematically in FIG. 4.

The drive train 1 is driven by a permanent magnet synchronous motor 20. The drive train 1 is connected at its output side (on the right in FIG. 1) to a loading system 10 of an aircraft. The loading system 10 may be, for example, a propeller or fan of an airplane, or the propeller of an airship or a drone. An airplane, an airship, or a drone are examples of aircraft.

These loading systems 10 mentioned have a relatively high rotational moment of inertia compared with the permanent magnet synchronous motor 20. In one embodiment, the permanent magnet synchronous motor 20 may be powered up relatively quickly when testing the torsional vibration behavior T in order to avoid undesired mechanical stimulations. Typical rotational moments of inertia of an electric drive for use in aviation are 0.05 kg*m². In the case of a load machine, the typical rotational moment of inertia is 5 kg*m², significantly higher. A propeller may have, for example, a rotational moment of inertia of 1.2 kg*m² and a rotor a rotational moment of inertia of 5.5 to 6.7 kg*m².

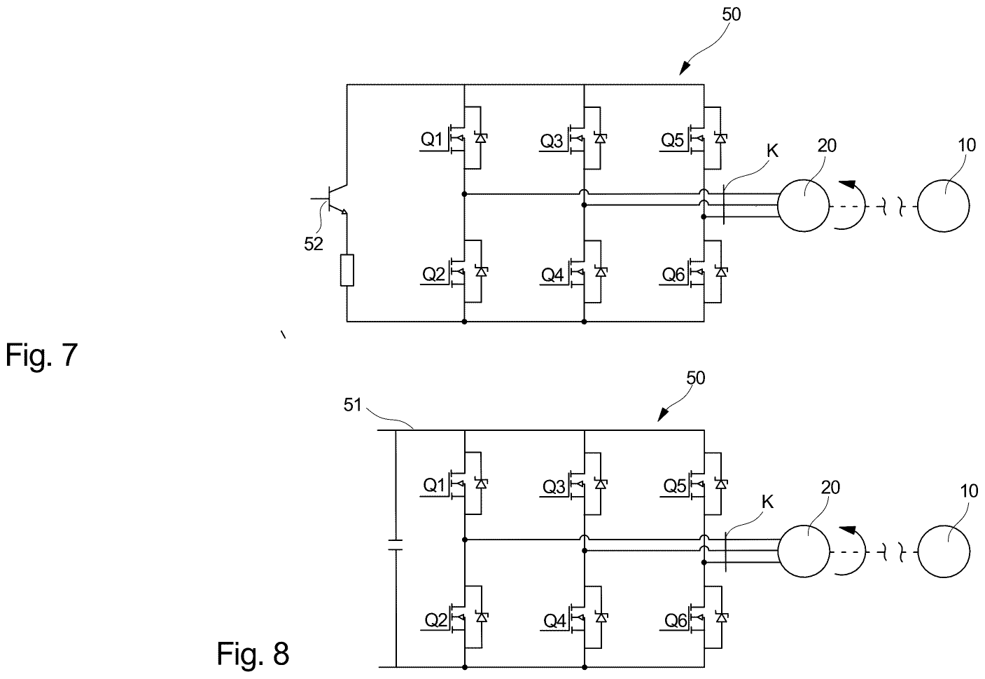

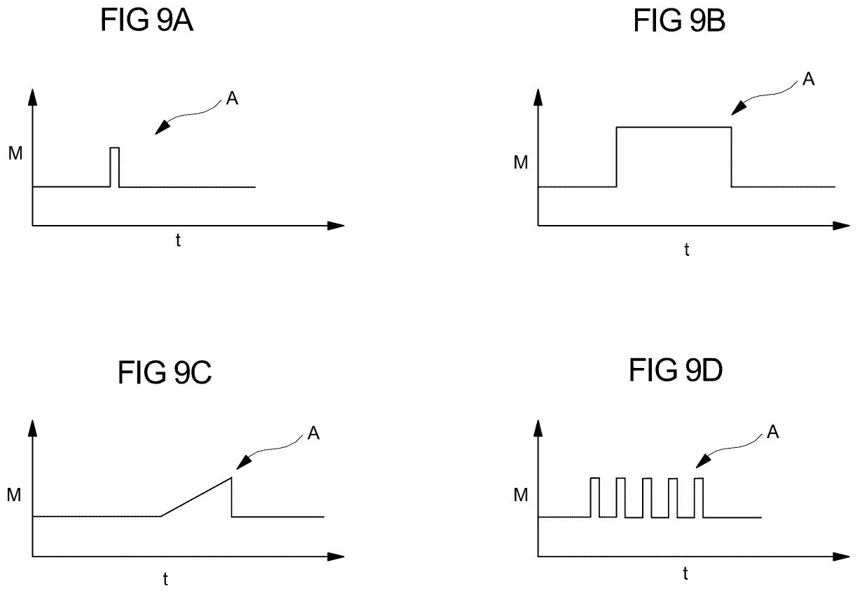

The permanent magnet synchronous motor 20 is coupled to a device 50 for generating at least one symmetrical 3-phase short circuit K. Embodiments for this device 50 are described in detail in conjunction with FIGS. 7 and 8.

A symmetrical 3-phase short circuit K may be the simultaneous short circuit of all three conductors U, V, W of the permanent magnet synchronous motor 20, which is also referred to as a shock short circuit (e.g., when initiated suddenly during operation) or as a three-pole short circuit.

When such a symmetrical 3-phase short circuit K is generated with a permanent synchronous motor 20 in operation, this induces a mechanical stimulation A (e.g., in the form of a shock) of the drive train 1, which constitutes mechanically a system of torsion springs/rotating masses.

There are in principle many types of short circuit in the case of a permanent magnet synchronous motor 20 with a three-phase current connection (e.g., symbolized in FIG. 1 by the lines U, V, W). Single-phase short circuits K or 2-phase short circuits K are thus also capable of effecting mechanical stimulation A of the drive train 1, such as generating a 3-phase short circuit K. The case of a 3-phase short circuit will generally be presented below without this implying any limitation.

The induced mechanical stimulation A is indicated in FIG. 1 by way of example and schematically as a pulse-like shock A. Very many frequencies of the oscillatory drive train 1 may be stimulated in the case of such a shock A of a sufficient magnitude and relatively short duration.

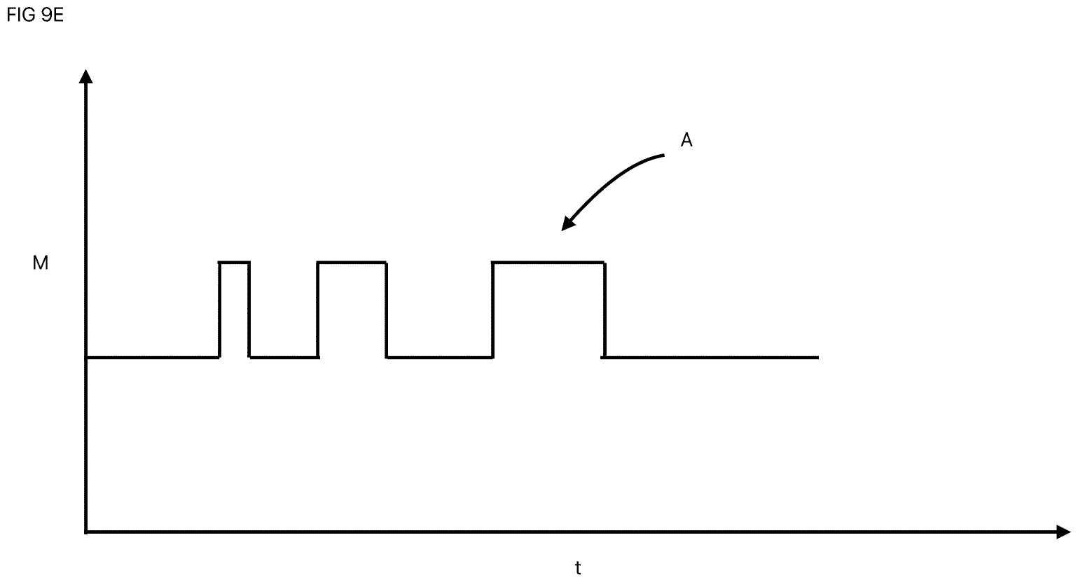

Different forms of induced mechanical stimulations A are described in FIGS. 9A to 9E.

In each case, the induced mechanical stimulation A causes a torsional vibration response T of the drive train 1.

The torsional vibration response T of the drive train 1 to the symmetrical 3-phase short circuit K may be detected by a sensor device 30 (e.g., in order to determine at least one natural frequency of the drive train). The sensor device 30 features, for example, optical and/or mechanical sensors that monitor the torsional vibration behavior T at one or more points of the drive train 1. In the example embodiment according to FIG. 1, the torsional vibration response T is in addition filtered via an optional high-pass filter 31 before the torsional vibration response T is analyzed (e.g., in the frequency domain).

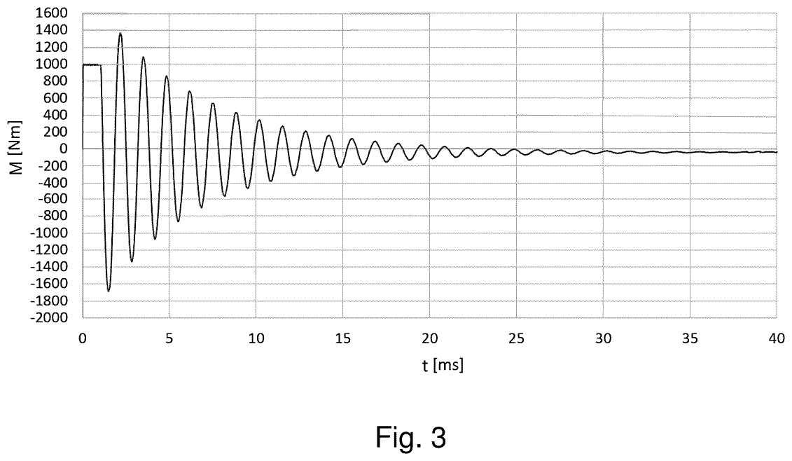

FIG. 3 shows by way of example a torsional vibration response T in the time domain (e.g., simulation result) that will be discussed further.

As also described below, statements about the mechanical behavior of the output train 1 may be derived from the torsional vibration response T. The sensor device 30 may also output and/or record a signal that is representative of the torsional vibration behavior T. Recording of a recurring signal may be, for example, as part of a machine learning process in conjunction with the engine health monitoring.

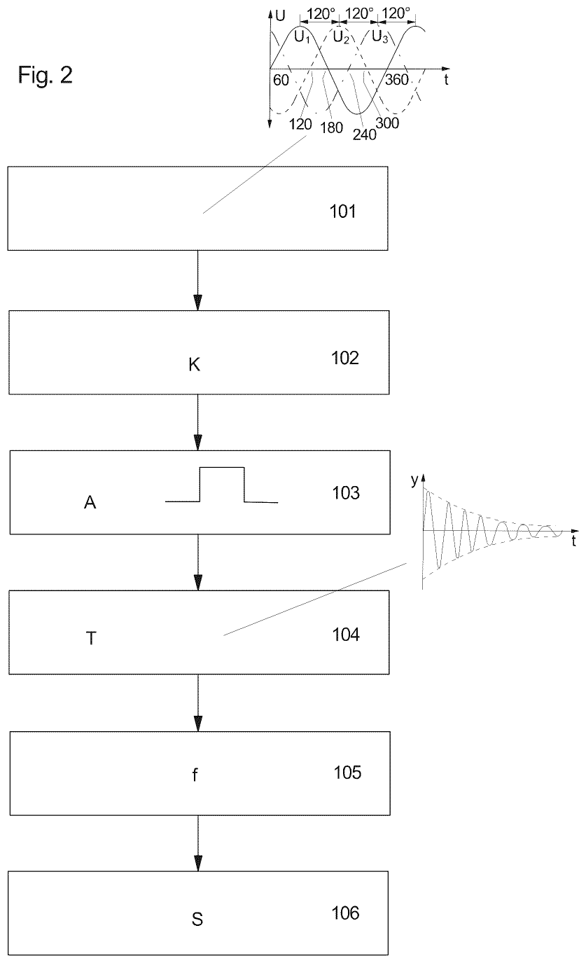

A first embodiment of a method for detecting the torsional vibration behavior T is illustrated in a flow chart by way of example in FIG. 2.

Starting from a first act 101 with a permanent magnet synchronous motor 20 in operation (e.g., number of revolutions sufficiently high, outside a resonant number of revolutions), a symmetrical 3-phase short circuit K is triggered at one point in time (e.g., act 102). At typical numbers of revolutions, the blade tip Mach numbers of the rotors and propellers are between 0.5<Ma<0.8. Fans may also rotate into the transonic range at the blade tips.

This symmetrical 3-phase short circuit induces (e.g., act 103) a mechanical stimulation A of the drive train 1 that causes a torsional vibration response T in the drive train 1 (e.g., act 104).

This torsional vibration response T of the drive train 1 is then detected and evaluated by the sensor device 30, for example, when coasting down (e.g., act 105) in order to determine, for example, a natural frequency f of the drive train 1.

If deviations of the natural frequency f from a nominal value are determined, this may, for example, trigger a signal S (e.g., act 106). The signal S may be, for example, a notification for a pilot that the drive train 1 is not working nominally. The signal S may, however, for example, also take the form of an automatic signal S that causes the unit to switch off when specific threshold values are exceeded, the number of revolutions to be reduced, or certain ranges of the number of revolutions to be restricted.

The sensor device 30 may also record the signals S over a longer period of time as part of engine health management in order to detect, for example, trends in the development of one or more natural frequencies f.

Because a symmetrical 3-phase short circuit K may be generated in a targeted fashion as described during operation of the permanent magnet synchronous motor 20, this is an efficient and adjustable way of applying a mechanical loading to the drive train 1 in a targeted fashion in order then to determine the torsional vibration response T of the drive train 1.

A plurality of such symmetrical 3-phase short circuits K may in principle also be applied to the drive train 1 in sequence such that complex dynamic loading patterns may be generated in the drive train 1 (see FIGS. 9A-9E).

A simulation result of a system (see illustration of the replacement oscillator system used in FIG. 4) with a permanent magnet synchronous motor 20 and with a drive train 1 coupled thereto is illustrated in FIG. 3.

At the point in time t=1.066 ms with a constant number of revolutions of the permanent magnet synchronous motor 20, a symmetrical 3-phase short circuit is applied. At the drive train 1, the sensor device 20 measures the torque M applied, which oscillates with a period of slightly more than 1 ms (approx. 1 kHz). Starting from a torque of 1000 Nm, the torque M oscillates to over −1600 Nm in the opposite direction of rotation, the torque M then oscillates back again to just short of 1400 Nm. The incipient torsional vibration T is clearly a damped vibration that has reached a value of −40 Nm after 40 ms. This provides that the amount of torque M has fallen to 4% of the initial value within 40 ms. With an induced mechanical stimulation A that causes this torque progression, a broadband stimulation of the drive train 1 into the kilohertz range or even into the range of tens of kHz is made possible.

In the embodiment illustrated, the sensor device 30 detects the torque M. In alternative embodiments, an angular value may alternatively or additionally also be detected. The angular value may be, for example, the angle of rotation of the drive train 1 about the axis of rotation, where the angle of rotation after the induced mechanical stimulation A displays similar damped torsional vibration behavior T to the torque M. The angular value may, however, also be a value other than the angle of rotation, such as the angular velocity or the angular acceleration. FIG. 3 is correspondingly also representative of such measurements.

The sensor device 30 may make statements about the mechanical state of the drive train 1 from the data of the torsional vibration behavior T of the time domain, as illustrated by way of example in FIG. 3. Thus, for example, changes over time in the amplitude behavior (e.g., decay behavior, logarithmic decrement, etc.) and/or the frequency may be compared with stored data for nominal operating states.

The induced mechanical stimulation A may be set such that the change in the torque M is no more than 50% of the applied or nominal torque M. If starting, for example, from a nominal torque 1500 Nm, a shock short circuit with a resulting torque difference of 500 Nm or less would over time apply less of a mechanical load on the drive train 1. It should in principle be noted that the fatigue resistance budget of the drive train 1 is not reduced excessively.

The dynamic progression of the torsional vibration behavior T from FIG. 3 is illustrated in FIG. 4 in the frequency domain in the form of a Bode diagram. The replacement oscillator system used in the simulation for the drive train 1 assumed as a coupled harmonic oscillator is illustrated schematically with four mass inertias and three oscillator/damper systems in the upper part of FIG. 4 (e.g., magnitude). This is to be understood merely as an example. As described in conjunction with FIGS. 1 and 2, the method may be performed with a real system such that in principle the method requires no replacement oscillator system.

The Bode diagram shows natural frequencies for the example system in FIGS. 3 and 4 at approximately 180 Hz, at 800 Hz, and at 2 kHz.

This shows that natural frequencies may be determined efficiently when an induced mechanical stimulation A is applied to the drive train 1 by a symmetrical 3-phase short circuit K.

Characteristic frequencies may be determined by the sensor device 30 using a Fourier analysis (e.g., a short-time Fourier analysis) of the measured torsional vibrations T.

In one embodiment, the torsional vibration response T may be filtered with a high-pass filter 31 in order to remove lower frequencies before the analysis by the sensor device 30.

As described above, it is possible to immediately utilize the data, detected by the sensor device 30, of the torsional vibration response T in order, for example, to indicate a malfunction or to store the data and subject the data to an evaluation (e.g., a statistical evaluation). This evaluation may take place, for example, as part of engine health management in the time and/or frequency domain.

Thus, for example, a change in the frequency and decay behavior of the torsional vibration response T may indicate a mechanical problem in the drive train 1. Current measured decay behavior may be compared with historical data of the same drive and/or also with other drives of possibly the same structure. In the case of a specific deviation from behavior classified as nominal, a corresponding signal S may be output.

It is analogously also possible to proceed with torsional vibration data T in the frequency domain by, for example, natural frequencies being compared with stored natural frequencies.

The evaluation may also be made jointly with data in the time and frequency domain.

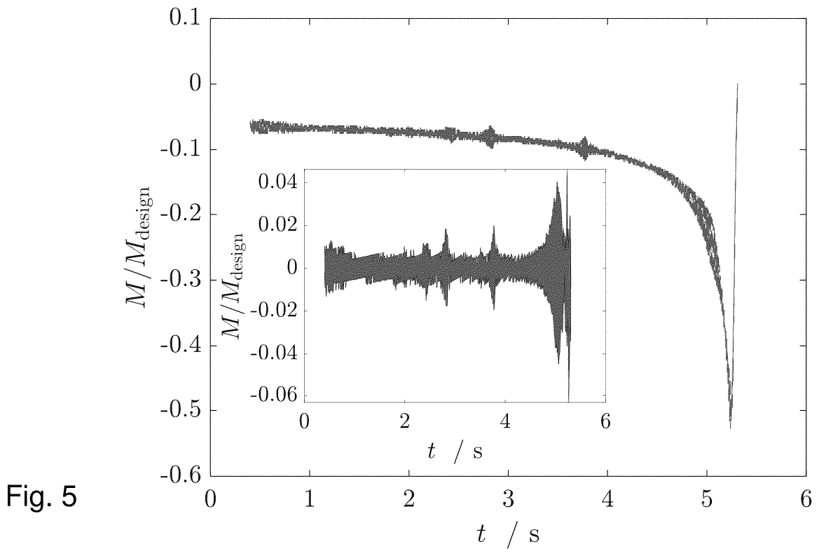

FIG. 5 shows an illustration of a measured torque M, standardized in relation to the nominal torque M_{Design} as a function of time. At the point in time 0.5 s, a symmetrical 3-phase short circuit has been triggered in a system that is comparable with that illustrated in FIG. 1. The subsequent trend that the standardized torque D decays slightly in the course of approximately 4 s but then intensifies is shown. Overall, an exponentially decaying process exists of the form 1−a e^{bx}. In the coasting down illustrated, the symmetrical 3-phase short circuit K is applied continuously. However, other mechanical stimulations, with correspondingly other vibration responses, may in principle also be used. After applying the short circuit, the coasting down may also take place with open terminals (e.g., open switches).

If the data is filtered with an IIR filter (e.g., solid smooth line in FIG. 5), this progression exists more or less. The small graph in FIG. 5 shows the high-pass-filtered signal.

However, the data determined does not show a smooth progression and instead shows relatively high-frequency peaks (e.g., the torsional vibrations T about this trend line). These are the torsional vibrations T that are detected and evaluated by the sensor device 30.

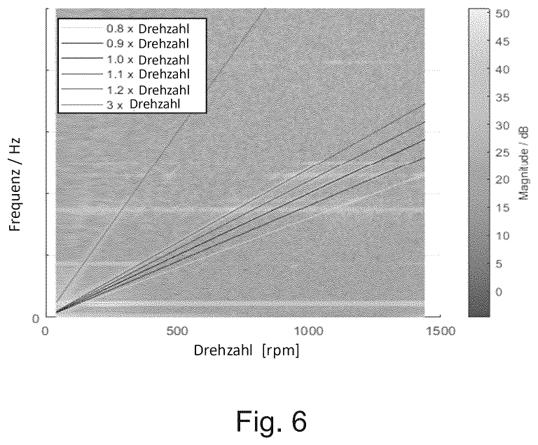

FIG. 6 shows a spectrograph of the torsional vibration responses T when the drive train 1 is coasting down after the mechanically induced stimulation A by the symmetrical 3-phase short circuit as a function of the number of revolutions of the drive train (x axis). FIG. 6 shows that at approximately 100 and 800 Hz, natural frequencies are present independently of the number of revolutions. At numbers of revolutions of up to approximately 300 rpm, a natural frequency of approximately 500 Hz is present, and at numbers of revolutions above 800 rpm, natural frequencies of 1 kHz are present. The mass, damping, and stiffness properties of the drive train 1 are dependent on the number of revolutions of the shaft (x axis). It follows that the natural frequencies calculated at a number of revolutions of the shaft may be unique to this number of revolutions. For this reason, it is appropriate to draw a diagram that shows the variation (e.g., the absolute values) of the natural frequencies with the number of revolutions of the shaft. When such a diagram is drawn, it is possible to superpose a number of lines that represent the variations in the number of revolutions of the shaft (see key upper left in FIG. 6). Using this representation, referred to as a Campbell diagram, it is possible to establish whether vibration sources (e.g., 1×, 2×, etc. the number of revolutions of the shaft) coincide with the natural frequencies of the drive train 1 and rotor resonances consequently occur.

Illustrated by way of example in FIGS. 7 and 8 are two power electronics circuits by which in each case a symmetrical 3-phase short circuit K may be triggered efficiently at the permanent magnet synchronous motor 20.

Illustrated in FIG. 7 is a 6-pulse rectifier known per se as a form of an active three-phase rectifier in which all the MOSFET switches Q1 to Q6 are open. When the transistor circuit 52 (e.g., an insulated-gate bipolar transistor (IGBT) circuit) is correspondingly connected at the direct-current input (on the left in FIG. 7), a symmetrical 3-phase short circuit K may be generated.

For the short circuit K, the switches Q1-Q6 are also to be connected conductively in the active rectifier. In the case of a passive rectifier, the switch on the direct-current is needed. When a battery is connected at the rectifier, two switches are needed in order to isolate the battery before the method is performed because otherwise the battery would be short-circuited.

Active rectifiers may be used in aircraft engines. Alternatively, passive rectifiers may also be used. Only the diodes in the Figure would need to be taken into account here. The parallel switches (Q1 to Q6) would then not be necessary.

Also illustrated in FIG. 8 is a 2-level inverter circuit known per se in which either the three upper switches Q1, Q3, Q5 or the three lower switches Q2, Q4, Q6 are switched on in order to generate the symmetrical 3-phase short circuit K.

These two types of circuit, the rectifier (e.g., FIG. 7) and the inverter (e.g., FIG. 8) are to be understood here only as examples because other circuits are also capable of generating a symmetrical 3-phase short circuit K.

For example, 2-phase short circuits K may be initiated via a normal inverter circuit. An additional device is needed for one-phase short circuits.

In the description above, pulse-like induced mechanical stimulations A (see FIG. 9A) or step-like induced mechanical stimulations A (see FIG. 9B) were, for example, mentioned. A very large number of frequencies may be stimulated in the drive train 1 by these forms of stimulation. Further, these forms of induced mechanical stimulation A may be generated efficiently by the symmetrical 3-phase short circuit K.

Other mechanical stimulations A may, however, also be induced in principle.

Illustrated in FIG. 9C is, for example, an induced mechanical stimulation as a ramp, the ramp having a slope of 45° or more than 45°, in order to provide an appreciable stimulation of the drive shaft 1. The slope may thus be generated in the case of an active converter circuit with a pulse width modulation. The mechanical loading when the short circuit K is initiated may thus be controlled.

It is, however, also possible that one of the induced mechanical stimulations A described in FIGS. 9A to 9C is generated periodically such that the drive train 1 experiences a series of mechanical stimulations. Thus, as illustrated in FIGS. 9D and 9E, multiple induced mechanical stimulations A (e.g., pulses or rectangular stimulations A) may be applied to the drive train 1, where the frequency of these mechanical stimulations A is matched to a predetermined frequency of the drive train 1.

Only some values that are typical for drives and drive trains used in aviation will be given below by way of example. Such a drive has, for example, an output of approximately 200 kW and operates nominally at 1300 rpm, which corresponds to 21.7 Hz. Typical numbers of revolutions are, for example, from 0 to 2500 rpm (e.g., from 0 to 42 Hz) of the output shaft.

Assuming 30 pole pairs of the drive, this results in an electrical frequency of 650 Hz at the nominal number of revolutions of 1300 rpm. The relevant natural frequency range may, for example, be between 10 and 5 kHz. As explained, these example numbers may provide, for example, the range of values within which embodiments of the method and the device may operate.

Assuming such a drive, repeated mechanical stimulations A may be applied to the drive train 1. In the case of short repeated stimulations A when coasting down, the vibration system is stimulated at different numbers of revolutions. A pulse may, for example, be used for speed steps of 10 to 50 rpm in order to sufficiently stimulate the resonance bands.

As shown in FIG. 3, a quarter period is achieved with the example system at the nominal number of revolutions in approximately 0.5 ms, which corresponds to reaching a torque amplitude (e.g., the electrical frequency is equivalent to the number of pole pairs multiplied by the mechanical frequency). In general, one amplitude (e.g., quarter period) or less should be enough to apply a sufficiently high stimulation (e.g., pulse). The pulse is to be introduced in the correct phase position (e.g., according to the measurable electrical voltage before the pulse, this is also possible). Shorter pulse lengths result in a lower mechanical loading but may be sufficient to stimulate the vibration system.

For the periodic stimulation A, this provides that very short pulses may be used at high numbers of revolutions. At low numbers of revolutions, a longer stimulation A is to be provided because the electrical frequency decreases in proportion to the number of revolutions. Adaptation of the pulse width may therefore be necessary, but this is possible using control technology.

Illustrated in FIG. 9E is, for example, a stimulation A in which the period and the pulse length increase over time.

With respect to the coasting down time, this depends on the rotational inertia and the brake torque of the system, and despite the high torque for a short time, short stimulations (e.g., pulses) result only in a small delay.

FIG. 5 shows the case with a continuously applied short circuit, in which a rotational-speed-dependent brake torque is applied correspondingly continuously. The procedure has therefore already ended after approximately 5 s. This procedure may accordingly last longer in the case of repeated short pulses.

It may be appropriate to use an installed self-test regulation system that may be used during ground operation in order to eliminate malfunctions during flight operation.

It is also possible that the at least one short circuit K (e.g., the at least one 2-phase short circuit and/or the symmetrical 3-phase short circuit) is maintained after initiation at least over part of the duration (e.g., all of the duration) for which the drive train 1 coasts down.

The number of revolutions in aircraft may be determined by the thrust generator (e.g., propeller, rotor, or fan) because its blade tip speed is limited by compressible flow effects. The number of revolutions in the case of eVTOLs is less than 2000 rpm, and in the case of propeller airplanes, the number of revolutions is up to 3000 rpm.

The embodiments of the method and the device may also be used in the case of gear box drives. The number of revolutions of the output shaft is, for example, reduced to the above-described level. The number of revolutions of the electric machine is consequently higher (e.g., as high as up to 20,000 rpm). For this, the number of pole pairs of the electric machine is lower such that the electrical frequencies remain in the range below 2000 Hz.

The method may also be used in the case of a generator of a serial or parallel hybrid drive system. The numbers of revolutions of the shaft, for example, may be as high as up to 20,000 rpm, and for this the number of pole pairs of the electric machine, is lower such that the electrical frequencies remain in the range below 2000 Hz.

At typical numbers of revolutions of aircraft, the blade tip Mach numbers of the rotors and propellers are between 0.5<Ma<0.8. Fans may also rotate into the transonic range at the blade tips.

The manner of the induced mechanical stimulations A does not have to be of the same type, as illustrated in FIG. 9D, and induced stimulations A of a different form may subsequently also be used, as illustrated by way of example in FIG. 9E.

The present embodiments are not limited to the embodiments described above, and different modifications and improvements may be made without deviating from the concepts described here. Any of the features may be used separately or in combination with any other features, unless the features are mutually exclusive, and the disclosure extends to and includes all combinations and subcombinations of one or more features that are described herein.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for detecting torsional vibration behavior of a drive train of an aircraft, wherein the drive train is coupled to a permanent magnet synchronous motor as a drive, the method comprising:
at least one triggering of a short circuit in the permanent magnet synchronous motor in an operating state, such that at least one induced mechanical stimulation of the drive train is applied; and
detecting, by a sensor device, a torsional vibration response of the drive train to the induced mechanical stimulation a sensor device.

2. The method of claim 1, further comprising determining at least one natural frequency, at least one resonant frequency, or the at least one natural frequency and the at least one resonant frequency of the drive train based on the detected torsional vibration response, in the case of a drive train that has substantially no torque load.

3. The method of claim 1, wherein the at least one induced mechanical stimulation of the drive train takes the form of a shock, a pulse, a step function, a ramp, or any combination thereof.

4. The method of claim 1, wherein the at least one induced mechanical stimulation of the drive train has a periodic form.

5. The method of claim 1, wherein the at least one induced mechanical stimulation comprises multiple induced mechanical stimulations applied to the drive train during coasting down, and
wherein the multiple mechanical stimulations are matched to a predetermined frequency of the drive train.

6. The method of claim 1, wherein the at least one short circuit takes place at a number of revolutions of the drive train in a range of the number of revolutions with no resonant frequency, and
wherein the drive train is load-free.

7. The method of claim 1, wherein the torsional vibration response is detected by the sensor device via measurement of at least one torque, at least one angular value, or the at least one torque and the at least one angular value.

8. The method of claim 7, wherein the angular value is an angle, an angular velocity, or an angular acceleration.

9. The method of claim 1, wherein the sensor device evaluates the torsional vibration response in the time domain.

10. The method of claim 9, further comprising determining decay behavior, the determining of the decay behavior comprising determining a logarithmic decrement of the torsional vibration response.

11. The method of claim 1, wherein the sensor device evaluates the torsional vibration response in the frequency domain using a short-time Fourier transform, a wavelet transform for detecting natural frequencies, resonant frequencies, or natural frequencies and resonant frequencies, or a combination thereof.

12. The method of claim 1, wherein the torsional vibration response is filtered by a high-pass filter, a band-pass filter, or the high-pass filter and the band-pass filter.

13. The method of claim 1, wherein the sensor device is coupled to an engine health monitoring system configured to store, evaluate, or store and evaluate the torsional vibration response over periods of time.

14. The method of claim 1, wherein the sensor device is configured to output a signal depending on the torsional vibration behavior.

15. The method of claim 1, wherein the mechanical stimulation is effected via an installed device that is coupled to the drive train and is utilizable during ground operation.

16. The method of claim 1, wherein the at least one short circuit is maintained after initiation at least over part of, in particular the whole duration for which the drive train (1) coasts down.

17. The method of claim 1, wherein the mechanical stimulation is effected periodically, and
wherein at least one known resonance band of the drive train is omitted by the periodic stimulation.

18. A device for detecting torsional vibration behavior of a drive train of an aircraft, wherein the drive train is coupled to a permanent magnet synchronous motor as a drive, the device comprising:
a short circuit generator configured to generate at least one short circuit in the permanent magnet synchronous motor, such that at least one induced mechanical stimulation of the drive train is applied; and
a sensor device configured to detect a torsional vibration response of the drive train to the at least one induced mechanical stimulation of the drive train for determination of at least one natural frequency of the drive train.

19. The device of claim 18, wherein the short circuit generator is configured to generate at least one 2-phase short circuit, at least one symmetrical 3-phase short circuit, or the at least one 2-phase short circuit and the at least one symmetrical 3-phase short circuit.

20. The device of claim 18, wherein the short circuit generator comprises an inverter circuit.

21. The device of claim 18, wherein the short circuit generator comprises a three-phase rectifier circuit with open switches, and
wherein a transistor circuit is arranged at a direct-current part as a switch.

22. The device of claim 18, wherein the mechanical stimulation is effected via an installed device that is coupled to the drive train and is utilizable during ground operation to eliminate malfunctions during flight operation.

23. An aircraft engine comprising:
a device for detecting torsional vibration behavior of a drive train of an aircraft, wherein the drive train is coupled to a permanent magnet synchronous motor as a drive, the device comprising:
a short circuit generator configured to generate at least one short circuit in the permanent magnet synchronous motor, such that at least one induced mechanical stimulation of the drive train is applied; and
a sensor device configured to detect a torsional vibration response of the drive train to the at least one induced mechanical stimulation of the drive train for determination of at least one natural frequency of the drive train.

24. The aircraft engine of claim 23, further comprising a propeller engine, a fan engine, a turbogenerator, or a hybrid drive system.

25. The aircraft engine of claim 23, wherein the aircraft engine is arranged in an airplane, an airship, or a drone.
